(19) United States
(12) Patent Application Publication
(10) Pub. No.: US 2016/0117509 A1
(43) Pub. Date: Apr. 28, 2016

(54) METHOD AND SYSTEM FOR KEEPING DATA SECURE

(71) Applicant: HON HAI PRECISION INDUSTRY CO., LTD., New Taipei (TW)

(72) Inventor: CHUN-TE WU, New Taipei (TW)

(21) Appl. No.: 14/839,263

(22) Filed: Aug. 28, 2015

(30) Foreign Application Priority Data
Oct. 28, 2014 (CN) 201410585856.X

(51) Int. Cl. G06F 21/60; G10L 19/022

(52) U.S. Cl. CPC G06F 21/60; G10L 19/022

(57) ABSTRACT

The present disclosure provides a method and system for keeping data secure. The method includes: acquiring at least one audio signal and assigning the segment to an audio frame having a predetermined size; partitioning the data to be kept into a plurality of portions with a maximum capable bit the data kept in each of the sampled points;

transforming the partitioned portions of the data into different frame sizes; framing each of the audio frames according to the plurality of frame sizes transformed; calculating an average value of the points in each frame, replacing a value of a first point within each frame with average value. The present disclosure can effectively resist noise jamming and bit replacement attacking.

### FIELD

The subject matter herein generally relates to a communication security technology, in particular to a method and a system for keeping data secure.

### BACKGROUND

Keeping data secure in audio data is generally written by using time domain or frequency domain, or using discrete wavelet transforming (DWT) or discrete cosine transforming (DCT), coefficients of plaintext or cipher hidden in the text. However the data kept in this way is easy infiltrated by noise or attacked by bit swap, such as a swap of odd points and even points, which can destroy the kept data.

### BRIEF DESCRIPTION OF THE DRAWINGS

Implementations of the present technology will now be described, by way of example only, with reference to the attached figures, wherein:

FIG. 1 illustrates a block diagram of an embodiment of an electronic device including a system for keeping data secure.

FIG. 2 illustrates a flowchart of an embodiment of a method for keeping data secure of the electronic device.

### DETAILED DESCRIPTION

The disclosure including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in hardware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives. The term “comprising”, when utilized, means “including, but not necessarily limited to”; it specifically indicates open-ended inclusion or membership in a so-described combination, group, series and the like.

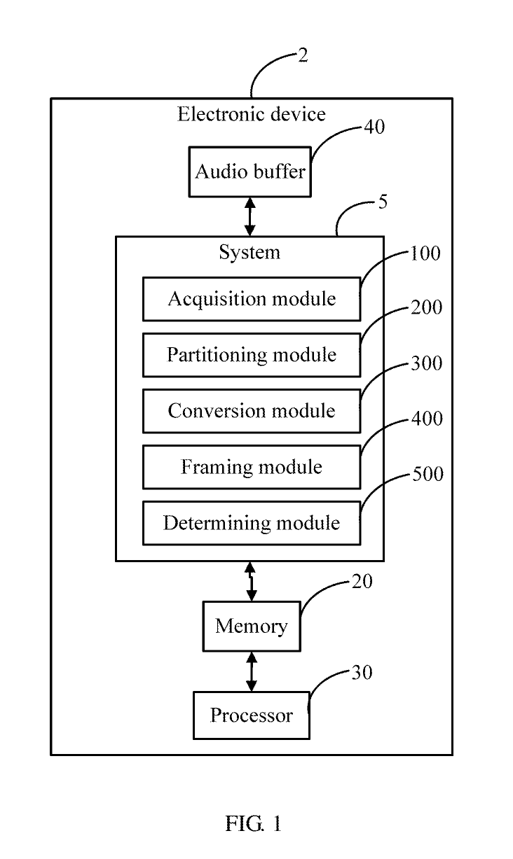

FIG. 1 illustrates a block diagram of an embodiment of an electronic device 2. In the illustrated embodiment, the electronic device 2 includes a system 5, a memory 20, a processor 30, and an audio buffer 40. The audio buffer 40 stores the preprocessed audio data.

The system 5 frames and averages the audio data from the audio buffer 40 to adjust the entropy of audio data to keeping data secure. The data includes the ID(Identification) or MAC(Media Access Control) address of the download device, user information, download date and time, etc.

In the illustrated embodiment, the system 5 includes an acquisition module 100, a partitioning module 200, a conversion module 300, a framing module 400 and a determining module 500. The modules are configured by the processor 30 executed to completion of the present disclosure. The present disclosure refers to the completion of a specific function of a module, the function of the module in this case is a segmenting of computer program. The memory 20 stores the program code and other information of the system 5.

The acquisition module 100 acquires one audio frame from the audio data in the audio buffer 40, according to a preset size of the audio frame. The audio frame comprises a plurality of sampled points. For example, the acquisition module 100 acquires one audio frame of 256 sampled points from the audio buffer 40 when the preset size of the audio frame is 256 sampled points.

The partitioning module 200 partitions the data to be keep in each of the audio frames into a plurality of portions according to a maximum capable bit the data kept in each of the plurality of the sampled points. For example, the data to be keep in the audio frames is 010111000011010101, and the maximum capable bit of data kept in each of the plurality of the sampled points is 3. So the partitioning module 200 partitions the data from the memory 20 or other electronic devices by 3 bits to get 010,111,000,011,010 and 101.

In the illustrated embodiment, the preset number of the entropy state of each sampled point can be 2, 4, 8, 16, 32, 64, 128 and 256, and the number of the entropy state determines the maximum capable bit. For example, the maximum capable bit N=8=log₂(256) bits when the preset number of the entropy state is 256, and the maximum capable bit N=3=log₂(8) bits when the preset number of the entropy state is 8, etc.

The conversion module 300 transforms the partitioned portions of the data into different frame sizes. In the illustrated embodiment, the partitioned portions of the data represent the identification of the frame sizes. For example, the partitioned portions of the data represent 8 types of frame sizes when the maximum capable bit N=3=log₂(8) bits. Then the partitioned portions of the data 010,111,000,011,010 and 101 respectively corresponds to the frame size of Class 2, Class 7, Class 0, Class 3, Class 2 and Class 5. A correspondence between the identification and the frame size is previously preset in a mapping table and stored in memory 20. For example, Class 2 corresponds to the frame size of 7 sampled points, Class 7 corresponds to the frame size of 20 sampled points, and Class 0 corresponds to the frame size of 2 sampled points. The conversion module 300 acquires the corresponding identifications according to the partitioned portion of the data, and queries the frame size from the mapping table according to the corresponding identification, then transforms the partitioned portions of the data into different frame sizes.

The framing module 400 frames each of the audio frames according to the plurality of frame sizes transformed, and calculates an average value of the points in each frame to replace a value of a first point of the corresponding frame of the sampled point by the average value. For example, the framing module 400 frames 7 consecutive sampled points from the first point in the frame of the audio data according to the frame size of Class 2, calculates the average value of the 7 points to replace the value of the first point in the frame, and translates back one sampled point. Then the framing module 400 frames the next 20 consecutive sampled points according to the frame size of Class 7, calculates the average value of the 20 points to replace the value of the first point in the frame, and so on.

The processed audio frames are put back to the audio buffer 40 to replace the corresponding original audio frames.

In the illustrated embodiment, data can be keep in the multi-channel audio data (for example, 5.1, 7.1, etc.), and the framing module 400 frames and averages a piece of data of one channel as the same as the other channels in the same audio frame when the audio data is multi-channel. The processed audio frames are put back to the audio buffer 40 to replace the corresponding original audio frames after the audio data of the audio frames in the multi-channel are completely processed.

The determining module 500 determines whether all the preprocessed audio data from the audio buffer 40 is processed, adjusts the entropy of the processed audio data to keep audio data when the preprocessed audio data from the audio buffer 40 is processed. Otherwise, the acquisition module 100 continues to acquire the preprocessed audio data from the next audio frame from the audio buffer 40, and repeats the above process until the preprocessed audio data is completely processed.

The electronic device 2 partitions the processed audio data and the original audio data into a preset size of a audio frame when the processed audio data is reading, and compares the calculated entropy of the audio data of the corresponding audio frame to decode the processed audio data to obtain the kept data. For example, the electronic device 2 takes out a frame of 256 sampled points of the processed audio data to divide the data into 50 bins within the range of (−1,1), then distributes statistics (calculates the number of sampled points of each bin) to correspondingly multiply by 1/50 and accumulate all, so that the entropy of the audio data of the audio frame compares with the entropy of the original audio data of the corresponding audio frame.

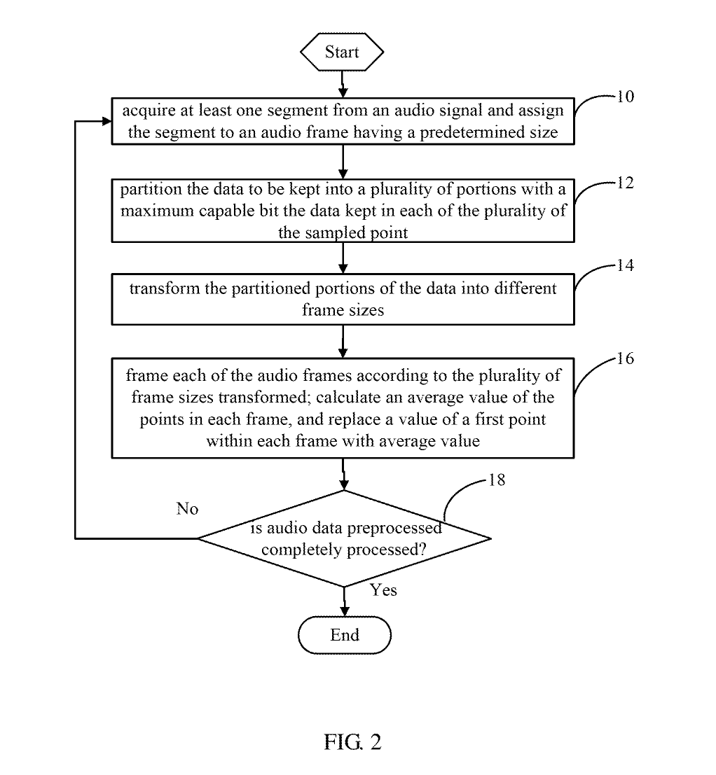

FIG. 2 illustrates a flowchart of an embodiment of a method for keeping data secure. The method applied in the electronic device 2 by the processor 30 executes program code stored in memory 20 to achieve. The system frames and averages the audio data from the audio buffer 40 to adjust the audio data entropy to keep data secure in the audio data.

At block 10, the acquisition module 100 acquires one audio frame from the audio data in the audio buffer 40, according to a preset size of the audio frame (for example, a frame of audio data contains 256 sampled points).

At block 12, the partitioning module 200 partitions the data to be kept in each of the audio frames to be a plurality of portions with a maximum capable bit the data kept in each of the plurality of the sampled points. For example, the data to be kept in the audio frames is 010111000011010101, and the maximum capable bit the data kept in each of the plurality of the sampled points is 3. So the partitioning module 200 partitions the data from the memory 20 or other electronic devices by 3 bits to get 010,111,000,011,010 and 101.

In the illustrated embodiment, the preset number of the entropy state of each sampled point can be 2, 4, 8, 16, 32, 64, 128 and 256, and the number of the entropy state determines the maximum capable bit. For example, the maximum capable bit N=8=log₂(256) bits when the preset number of the entropy state is 256, and the maximum capable bit N=3=log₂(8) bits when the preset number of the entropy state is 8, etc.

At block 14, the conversion module 300 transforms the partitioned portions of the data into different frame sizes. In the illustrated embodiment, the partitioned portions of the data represent the identification of the frame sizes. For example, the partitioned portions of the data represent 8 types of frame sizes when the maximum capable bit N=3=log₂(8) bits. Then the partitioned portion of the data 010,111,000,011,010 and 101 respectively corresponds to the frame size of Class 2, Class 7, Class 0, Class 3, Class 2 and Class 5. A correspondence between the identification and the frame size is previously preset in a mapping table and stored in memory 20. For example, Class 2 corresponds to the frame size of 7 sampled points, Class 7 corresponds to the frame size of 20 sampled points, and Class 0 corresponds to the frame size of 2 sampled points. The conversion module 300 acquires the corresponding identifications according to the partitioned portions of the data, and queries the frame size from the mapping table according to the corresponding identification, then transforms the partitioned portions of the data into different frame sizes.

At block 16, the framing module 400 frames each of the audio frames according to the plurality of frame sizes transformed, and calculates an average value of the points in each frame to replace a value of a first point within each frame with average value. For example, the framing module 400 frames 7 consecutive sampled points from the first point in the frame of the audio data according to the frame size of Class 2, calculates the average value of the 7 points to replace the value of the first point in the frame, and translates back one sampled point. Then the framing module 400 frames the next 20 consecutive sampled points according to the frame size of Class 7, calculates the average value of the 20 points to replace the value of the first point in the frame, and so on. The processed audio frames are put back to the audio buffer 40 to replace the corresponding original audio frames

In the illustrated embodiment, data can be kept in the multi-channel audio data (for example, 5.1, 7.1, etc.), and the framing module 400 frames and averages a piece of data of one channel as the same as the other channels in the same audio frame when the audio data is multi-channel. The processed audio frames are put back to the audio buffer 40 to replace the corresponding original audio frames after the audio data of the audio frames in the multi-channel is completely processed.

At block 18, the determining module 500 determines whether all the preprocessed audio data from the audio buffer 40 is processed, adjusts the entropy of the processed audio data to keep data secure when the preprocessed audio data from the audio buffer 40 is processed. Otherwise, back to block 10, the acquisition module 100 continues to acquire the preprocessed audio data from the next audio frame from the audio buffer 40, and repeats the process of block 12-16 until the preprocessed audio data is completely processed.

The electronic device 2 partitions the processed audio data and the original audio data into a preset size of a audio frame when the processed audio data is read, and compares the calculated entropy of the audio data of the corresponding audio frame to decode the processed audio data to obtain the data kept.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A method for keeping data secure in audio data, comprising:
acquiring at least one segment from an audio signal and assigning the segment to an audio frame having a predetermined size, the audio frame comprising a plurality of sampled points;
partitioning the data to be kept into a plurality of portions with a maximum capable bit the data kept in each of the plurality of the sampled point;
transforming the partitioned portions of the data into different frame sizes;
framing each of the audio frames according to the plurality of frame sizes transformed; and
calculating an average value of the points in each frame, and replacing a value of a first point within each frame with average value.

2. The method as claimed in claim 1, wherein the maximum capable bit is determined according to a number of species of a preset entropy state comprised in each of the sampled points.

3. The method as claimed in claim 1, wherein transforming the partitioned portions of the data into different frame sizes comprising: acquiring the corresponding identifications according to the partitioned portions of the data, querying the frame size from the mapping table according to the corresponding identification, transforming the partitioned portions into different frame sizes.

4. The method as claimed in claim 3, wherein the partitioned portions of the data represents the identifications of the frame sizes, a correspondence between the identification and the frame size is previously preset in a mapping table.

5. The method as claimed in claim 1, wherein framing and averaging a piece of data of one channel as the same as the other channels in the same audio frame when the audio data is multi-channel.

6. A system for keeping data secure in audio data, comprising:
a acquisition module, acquiring at least one audio signal and assigning the segment to an audio frame having a predetermined size, the audio frames comprising a plurality of sampled points;
a partitioning module, partitioning the data to be kept into a plurality of portions with a maximum capable bit the data kept in each of the plurality of the sampled points;
a conversion module, transforming the partitioned portions of the data into different frame sizes; and
a framing module, framing each of the audio frames according to the plurality of frame sizes transformed, and calculating an average value of the points in each frame, and replacing a value of a first point within each frame with average value.

7. The system as claimed in claim 6, wherein a determining module to determine whether all audio data preprocessed processed, trigger the acquisition module continues to select the next audio frame to processing when the data has not been processed.

8. The system as claimed in claim 6, wherein the maximum capable bit is determined according to a number of species of a preset entropy state comprised in each of the sampled points.

9. The system as claimed in claim 6, wherein a conversion module acquires the corresponding identifications according to the partitioned portions of the data, queries the frame size from the mapping table according to the corresponding identification, and transforms the partitioned portions of the data to be a plurality of frame sizes.

10. The system as claimed in claim 9, wherein the partitioned portions of the data represent the identifications of frame sizes, and a correspondence between the identification and the frame size is previously preset in a mapping table.

11. The system as claimed in claim 6, wherein the framing module frames and averages a piece of data of one channel as same as the other channel in the same audio frame when the audio data is multi-channel.
